(19) United States
(12) Patent Application Publication
(10) Pub. No.: US 2007/0140436 A1
(43) Pub. Date: Jun. 21, 2007

(54) Dual telescoping support member digital radiography imaging system

(75) Inventors: Ronald J. Perry, Webster, NY (US); James W. Sekol, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/438,981

(22) Filed: May 23, 2006

Related U.S. Application Data
(63) Continuation-in-part of application No. 11/304,837, filed on Dec. 15, 2005, now abandoned.

(51) Int. Cl. H05G 1/02

(52) U.S. Cl. 378/197

(57) ABSTRACT

A digital radiography system, having an X-ray source and an X-ray imaging detector, for capturing an image of a subject. The system has a moveable base that is translatable along two separate directions to a location selected by an operator. The system has a first rotatable telescoping support member coupled to the moveable base, the X-ray source being rotatably coupled to the first rotatable telescopic support member, and being adapted to translate and rotate to locate the X-ray source in a position selected by the operator. The system further has a second rotatable telescoping support member coupled to the moveable base, the X-ray imaging detector being rotatably coupled to the second rotatable telescoping support member, and being adapted to translate with the moveable base and rotate to locate the X-ray imaging detector in a position selected by the operator.

### CROSS REFERENCE TO RELATED APPLICATIONS

This is a continuation-in-part of application Ser. No. 11/304,837, filed Dec. 15, 2005 entitled “DUAL TELESCOPING SUPPORT MEMBER DIGITAL RADIOGRAPHY IMAGING SYSTEM” by Ronald J. Perry and James W. Sekol.

### FIELD OF THE INVENTION

The invention relates generally to digital radiography, and in particular a digital radiography imaging system with moveable telescoping support members for positioning an X-ray source and an X-ray imaging detector for capturing an image of a subject.

### BACKGROUND OF THE INVENTION

Digital radiography systems are well known. In typical digital radiography systems, an X-ray source projects an X-ray beam through a subject (such as a body part of an individual) to produce an X-ray image captured by a detecting member. The detector member relies on direct conversion of X-rays to charge carriers and charge readout. Alternatively, the detector can rely on indirect conversion in which X-rays are converted to light, which is then converted to charge carriers and charge readout.

The detector is typically mounted in a structure known as a bucky. The bucky can also house other elements such as an anti-scatter grid which is commonly used to prevent scattered radiation from affecting the final X-ray image. Such anti-scatter grids are typically employed when the subject to be imaged is relatively thick (for example, a human chest).

The X-ray source or X-ray detector can be mounted in various configurations. For example, the X-ray detector can be mounted on an X-ray table or on a radiographic stand, as shown in FIGS. 1A and 1B, respectively, wherein the X-ray imaging detector is element 10. As shown in FIGS. 1A and 1B, the X-ray source (element 15) is mounted on a support structure.

However, such configurations shown in FIGS. 1A and 1B require access to the floor. That is, the support structure(s) for the X-ray source or X-ray detector requires access to the floor. In some situations, such floor access may not be possible, for example, if there is limited space. In other situations, such a floor-based support structure may not be desired, for example, in an emergency room wherein equipment may need to be moved quickly.

As such, there exists a need for a digital radiography system that is not supported by a floor-based support structure and that allows an operator to locate the X-ray source and X-ray imaging detector in a variety of positions for imaging a subject.

### SUMMARY OF THE INVENTION

In accordance with the invention, there is a digital radiography system for permitting capture of an image of a subject, having:
(a) an X-ray source and an X-ray imaging detector;
(b) a moveable base, translatable along two separate directions to a location selected by an operator;
(c) a first rotatable telescoping support member coupled to the moveable base, the X-ray source being rotatably coupled to the first rotatable telescopic support member, and being adapted to translate and rotate to locate the X-ray source in a position selected by the operator; and
(d) a second rotatable telescoping support member coupled to the moveable base, the X-ray imaging detector being rotatably coupled to the second rotatable telescoping support member, and being adapted to translate with the moveable base and rotate to locate the X-ray imaging detector in a position selected by the operator, whereby the movement of the moveable base and the translation and rotation respectively of the first and second telescoping support members positions the X-ray source and the X-ray imaging detector so that an image of the subject can be captured.

### Advantages

One advantage of the present invention is that the X-ray source and X-ray imaging detector can each be independently moved in a variety of different positions by an operator for capturing an image of a subject. Another advantage of the present invention is that it reduces the mechanical bulk and complexity of typical imaging systems and allows for independent adjustability of the positioning of the X-ray source and the X-ray detector. These advantages are given only by way of illustrative example, and such advantages are exemplary of one or more embodiments of the invention. Other desirable advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings.

FIGS. 1A and 1B show prior art mounting configurations for a digital radiography system.

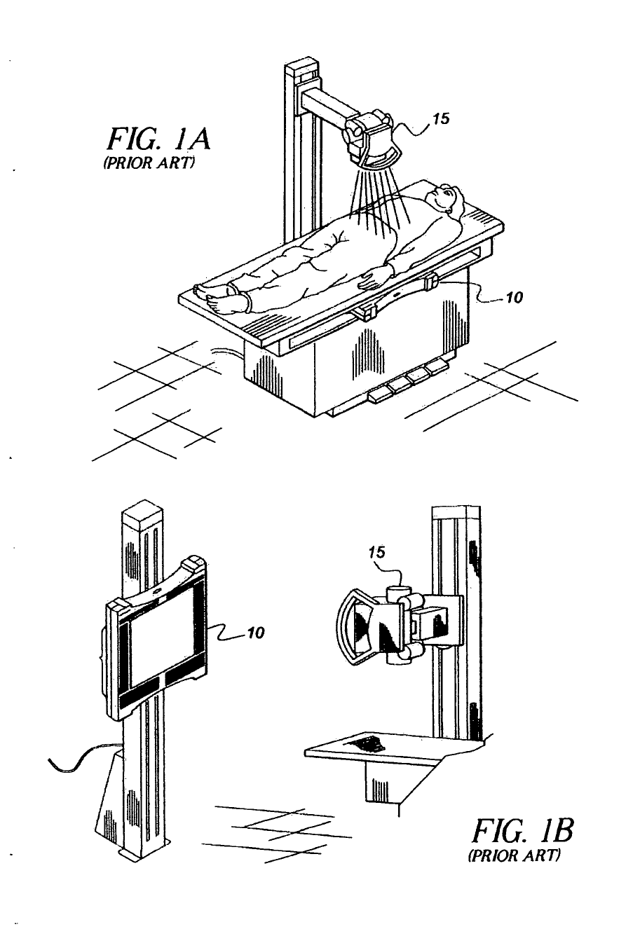

FIG. 2 shows a diagrammatic perspective of a digital radiography system in accordance with the present invention.

FIG. 3 shows another diagrammatic perspective of the digital radiography system in accordance with the present invention.

FIG. 4 shows a diagrammatic perspective of the X-ray imaging detector with multiple rotational couplings to a telescoping member in the digital radiography system in accordance with the present invention.

FIG. 5 shows a cross-section view of a telescoping support member of the digital radiography system in accordance with the present invention.

FIG. 6 shows a cross-section view of the X-rails, Y-rails, and carriage assemblies of the rail structure of the digital radiography system in accordance with the present invention.

FIG. 7 shows a diagrammatic perspective of the moveable base of the digital radiographic system can move in a predetermined path moveable rail structure of the digital radiography system in accordance with the present invention.

### DETAILED DESCRIPTION OF THE INVENTION

The following is a detailed description of the preferred embodiments of the invention, reference being made to the drawings in which the same reference numerals identify the same elements of structure in each of the several figures.

The present invention provides a digital radiography (DR) system with an X-ray source and an X-ray imaging detector that each can be independently moved in a variety of directions by an operator such the X-ray source and X-ray imaging detector can be positioned for capturing an image of a subject. Once positioned, the X-ray source projects an X-ray beam through the subject to produce an X-ray image captured by the X-ray imaging detector.

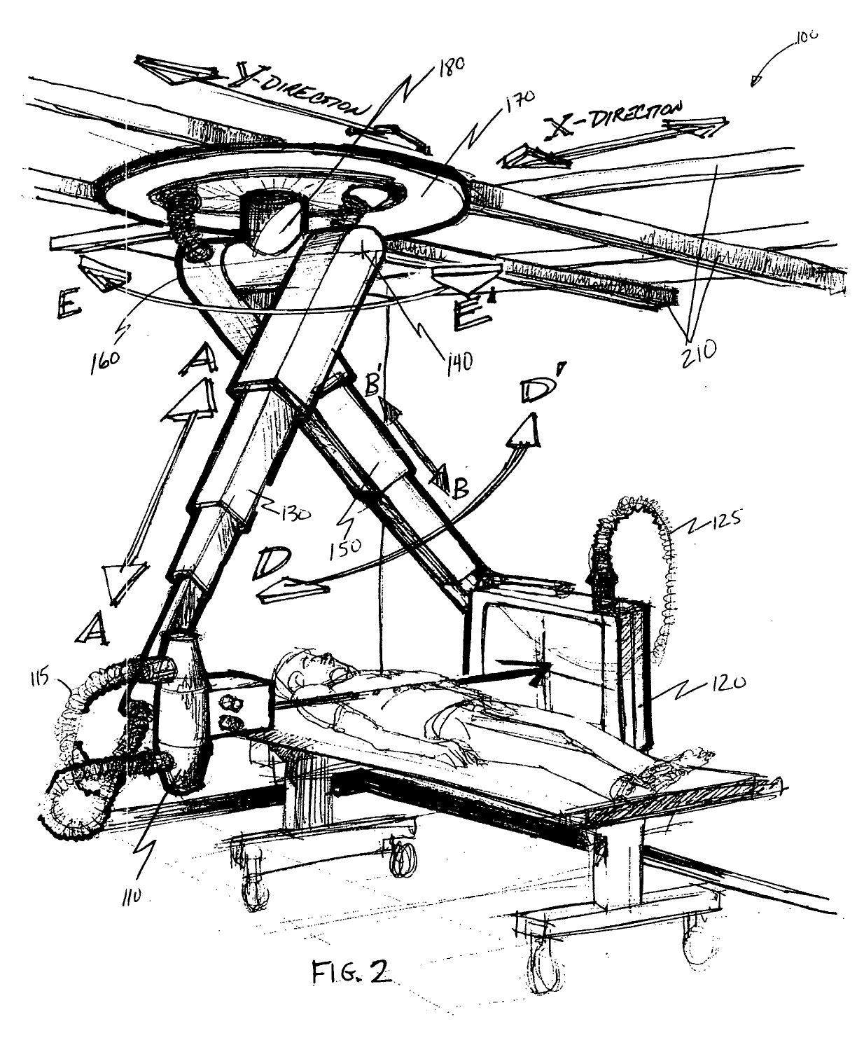

FIG. 2 illustrates a diagrammatic perspective of a digital radiography (DR) system 100 in accordance with the present invention. DR system 100 includes X-ray source 110 coupled to first telescoping support member 130. X-ray source cables 115, which control the operation of and communicate with X-ray source 110, are connected to X-ray source 110 and can be routed internally through first telescoping member 130. Opposite from X-ray source 110 on first telescoping support member 130 is pivot point 140, which connects first telescoping member 130 to rotational mechanism 180, where rotational mechanism 180 is in turn coupled to moveable base 170.

Similarly, as shown in FIG. 2, X-ray imaging detector 120 is coupled second telescoping support member 150. X-ray imaging detector cables 125, which control the operation of and communicate with X-ray imaging detector 120, can be routed through second telescoping support member 150. One advantage of routing X-ray imaging detector cables 125 through second telescoping support member 150, as well as routing X-ray source cables 115 though first telescoping member 130, is that the configuration can prevent objects that are to be imaged from becoming intertwined with typical, non-internally routed cabling. Opposite X-ray imaging detector 120 on telescoping support member 150 is second pivot point 160, which is coupled to rotational mechanism 180 and moveable base 170. As illustrated in FIG. 2, first pivot point 140 and second pivot point 160 are located adjacent to one another and are coupled to rotational mechanism 180. Moveable base 170 can moved in various positions in a predetermined path in the X- or Y-directions (shown in FIGS. 2, 3 and 6) along rail structure 210.

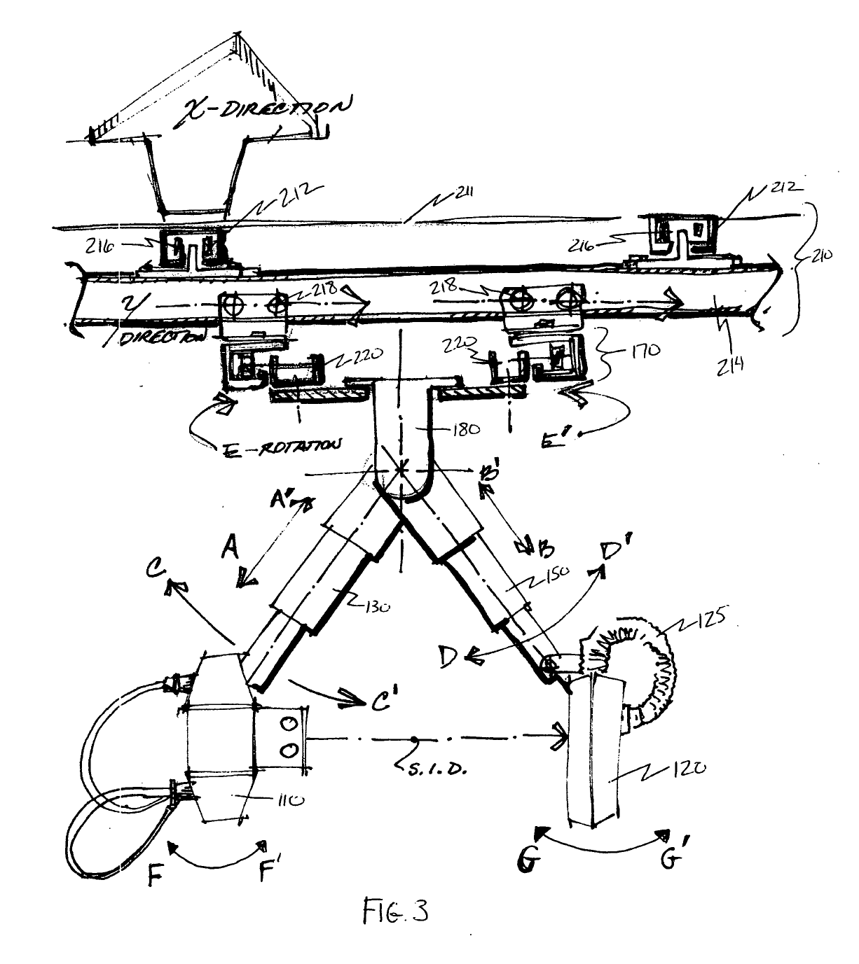

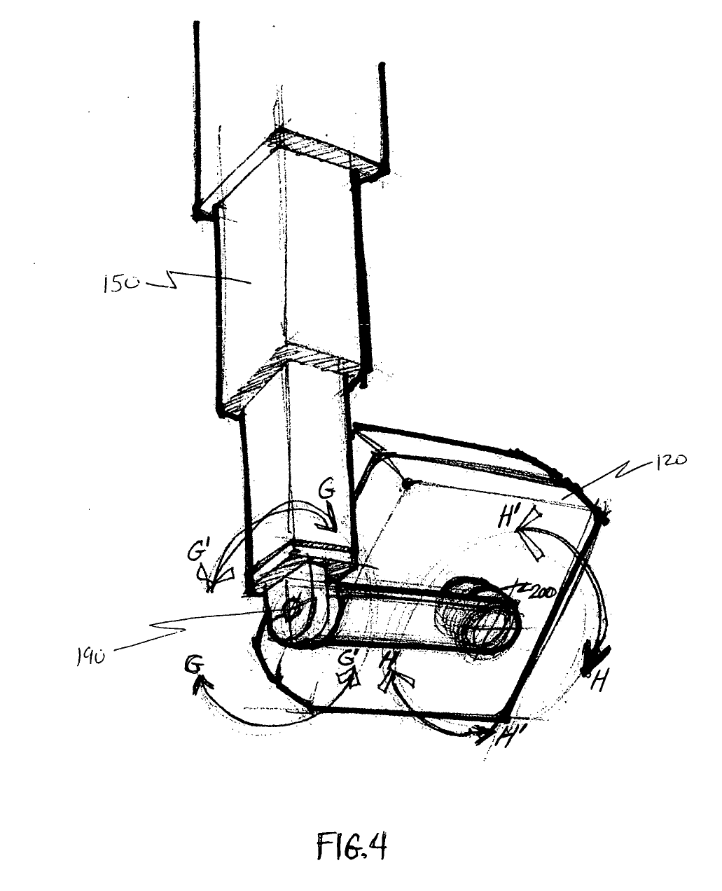

As illustrated in FIG. 4, X-ray imaging detector 120 is coupled to rotational coupling 190, which, in turn, is coupled to second telescoping support member 150 so as to allow rotational movement of X-ray imaging detector 120 in directions G or G′ (shown in FIGS. 3 and 4) relative to telescoping support member 150. As additionally shown in FIG. 4, X-ray imaging detector 120 is coupled to rotational coupling 200, wherein rotational coupling 200 is further coupled to rotational coupling 190 and second telescoping support member 150. Rotational coupling 200 allows an operator to rotationally move X-ray imaging detector 120 in the H or H′ directions, as indicated in FIG. 4. Similarly, X-ray source 110 has rotational coupling (not shown) similar to rotational coupling 190, which couples X-ray source 110 to first telescoping support member 130. X-ray source 110's rotational coupling permits an operator to rotationally move X-ray source 110 in the F or F′ directions (shown in FIG. 3) relative to first telescoping support member 130.

As shown in FIGS. 2 and 3, first telescoping support member 130 can extend in the A direction or retract in the A′ direction in order to position X-ray source 110 for imaging a subject. Similarly, second telescoping support member 150 can extend in the B direction or retract in the B′ direction in order to position X-ray imaging detector 120 for capturing an image of a subject.

First and second telescoping support members 130 and 150 can be adapted to move translationally between a variety of positions in the respective A, A′, B, or B′ directions, which can vary between a collapsed position and an extended position. That is, first and second telescoping support members 130 and 150 are configured to slide inward and outward in overlapping sections. In a collapsed position, first and second telescoping support members 130 or 150 may be disposed towards moveable base 170 (i.e., close to the ceiling). In an extended position, first and second telescoping support members 130 or 150 may be disposed away from moveable base 170 (i.e., close to the floor). In addition, first and second telescoping support members 130 and 150 may be extended at discrete positions intermediate to the collapsed and extended positions. This motion allows for the imaging of objects of various heights and orientations between telescoping support members 130 and 150 collapsed and extended positions.

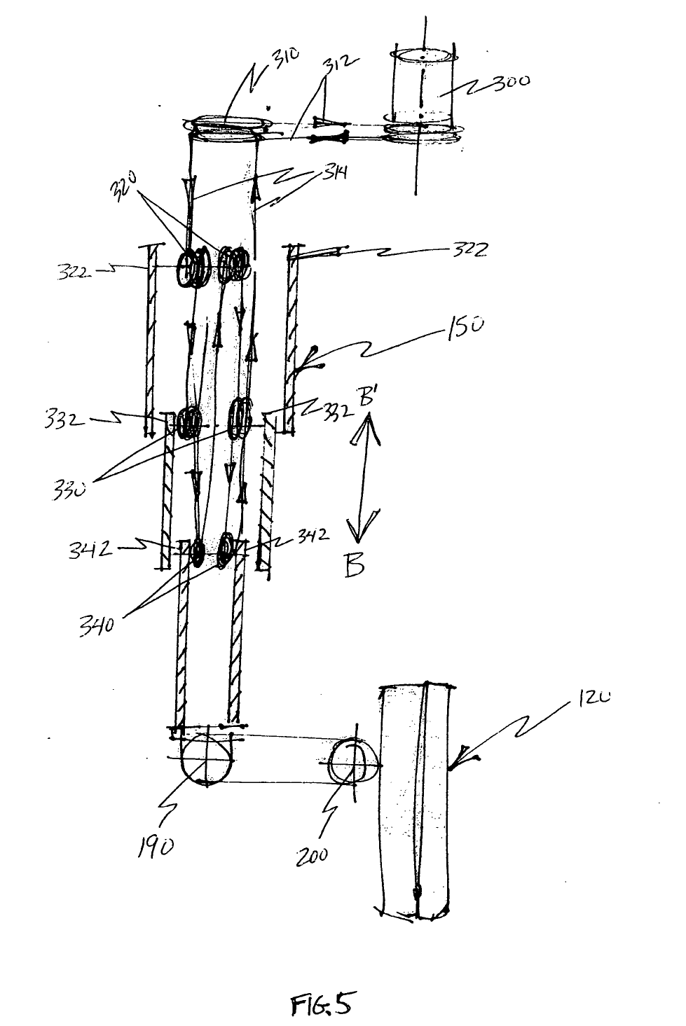

A cross-section view of telescoping support member 150 is illustrated in FIG. 5. Motor 300 is activated by changes in load caused by the operator moving telescoping support member 150 in the B or B′ directions. The motor drives cables 312, which in turn moves horizontal pulley 310. First pulleys 320 are attached to the top of first tube section 322 of second telescoping support member 150. Similarly, second pulleys 332 are mounted at the top of second tube section 332, and third pulleys 340 are mounted at the top of third tube section 342 of second telescoping support member 150. Cables 314 mechanically connect horizontal pulley 310 with first pulleys 320, second pulleys 330, and third pulleys 342. Thus, motor 300 drives cables 312 and 314 to move telescoping support member in the B or B′ directions, where third tube section 342 can move within second tube section 332, and both second and third tube sections 332 and 342 can move within first tube section 322 of second telescoping member 150. Similarly, the overlapping tube sections of first telescoping support member 130 (see FIG. 3) can operate in a similar manner such that the operator of DR system 100 can move first telescoping support member 130 in the A or A′ directions.

Turning again to FIGS. 2 and 3, by pivoting at first pivot point 140, telescoping support member 130 can be moved in the C or C′ directions (as illustrated in FIG. 3) so that an operator can position X-ray source 110. Similarly, telescoping support member 150 can move in the D or D′ directions (also illustrated in FIG. 3) so as to position X-ray imaging detector 120. An operator moving telescoping support members 130 and 150 apart from each other, thus respectively moving X-ray source 110 and X-ray imaging detector 120, enables capturing an image of a subject.

In addition, rotational mechanism 180, as shown in FIGS. 2 and 3, can allow an operator to rotate telescoping support members 130 and 150 in the E or E′ directions (shown in FIGS. 2 and 3), and thus respectively move X-ray source 110 and X-ray imaging detector 120 into various positions to allow for imaging of a subject. Additionally, moveable base 170, to which telescoping support members 130 and 150 are coupled to by rotational mechanism 180, can be moved in a predetermined path in the X-direction and Y-direction on rail structure 210. Movement in the X-direction or Y-direction can position X-ray source 110 and X-ray imaging detector 120 for imaging a subject.

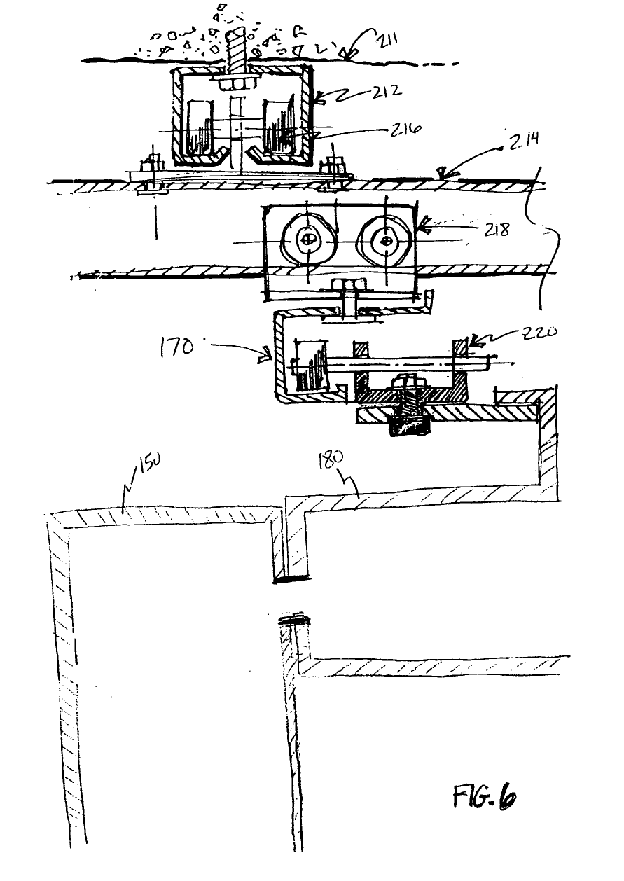

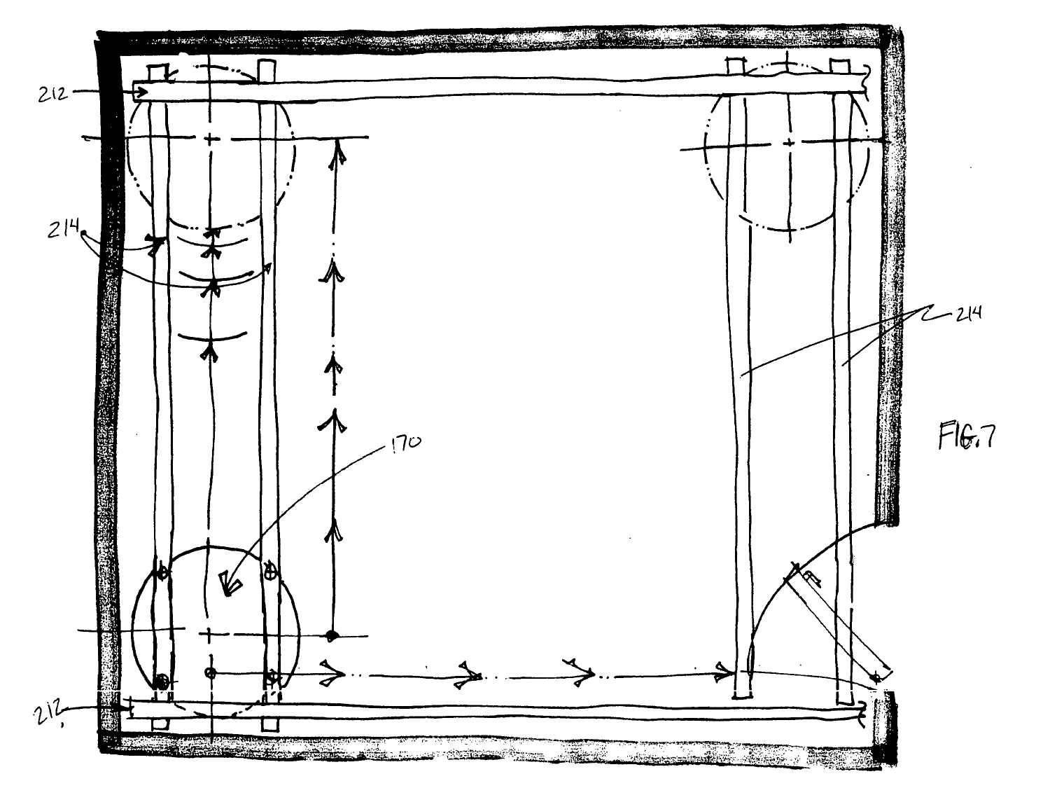

FIG. 6 illustrates cross-section view of the rail structure 210, including X-rails 212, Y-rails 214, and first, second, and third carriage assemblies 216, 218, and 220 of DR system 100. As shown, X-rails 212 are affixed to ceiling 211. First carriage assembly 216, which is affixed to Y-rails 214, can move within X-rails 212. First carriage assembly 216 can have wheels, bearings, or other suitable mechanisms that allow for movement within the X-rails 212. In this arrangement, X-rails 212 are affixed to ceiling 211, and Y-rails 214 are suspended from X-rails 212 by first carriage assembly 216. Second carriage assembly 218 is located within Y-rails 214. Similar to first carriage assembly 216, second carriage assembly 218 can have wheels, bearings, or other suitable mechanisms that allow for movement of second carriage assembly within Y-rails 214. Moveable base 170 can be attached to second carriage assembly 218. Thus, X-rails 212, Y-rails, 214, first carriage assembly 216, and second carriage assembly 218 allow an operator to move moveable base 170 in the X-direction or Y-direction about a room as illustrated in FIG. 7. Third carriage assembly 220 is a component of rotational mechanism 180, and allows for rotation of DR system 100 in the E or E′ directions (see FIG. 3). Third carriage assembly 220 has wheels, bearings or other suitable mechanisms that allow rotational mechanism 180 to operate (and thus rotate first and second telescoping support members 130 and 150 in the E or E′ directions) within moveable base 170.

FIG. 7 illustrates a top view of a room where DR system 100 can be installed. As shown, rail structure 210 can include X-rails 212 and Y-rails 214. In one aspect of the embodiment, X-rails 212 can be affixed to the ceiling of the room, as illustrated in FIG. 7. Y-rails 214 can be mounted from a carriage assembly with roller bearings, wheels, or other suitable mechanisms for movement inside X-rails 212. Moveable base 170 is mounted a carriage assembly which moves on Y-rails 214, and can be moved by an operator in a predetermined path in the X-direction or Y-direction about the room, as illustrated in FIG. 7. The configuration of X-rails 212 and Y-rails 214 allow an operator to position DR system 100 at any location within a room. Also, as DR system 100 is suspended from ceiling on rail structure 210, it does not occupy any floor space with support structure, unlike other systems. DR system 100 has an additional advantage over present systems in that when DR system 100 is not in use, it can be moved on rail structure 210 to a corner location of a room.

The movements in the above-described directions permit an operator of DR system 100 to achieve an appropriate source-to-image distance (S.I.D.) for capturing an image of a subject. The S.I.D., as illustrated in FIG. 3, is the linear distance between X-ray source 110 and X-ray imaging detector 120. Movement of first and second telescoping support members 130 and 150 in directions A, A′, B, B′, C, C′, D, or D′ directions by an operator can be used to achieve S.I.D. First and second telescoping members can be moved by an operator in directions A, A′, B, or B′ as needed in order to place X-ray source 110 and X-ray imaging detector 120 a suitable distance apart for imaging a subject. As further shown in FIG. 3, first telescoping support member 130 can be moved by an operator in either the C or C′ directions, and second telescoping support member 150 can be moved in the D or D′ directions. The positioning of the X-ray source 110 and X-ray imaging detector 120 to the SID distance can accommodate a variety of subjects in various positions (e.g., seated, reclining, etc.) for imaging.

Depending on the subject to be imaged, as well as the orientation of the subject, the S.I.D. can vary in linear distance. For example, the S.I.D. for a patient in a reclined position can be different from the S.I.D. of a seated patient to be imaged. Also, the vertical or horizontal positioning of X-ray source 110 or X-ray imaging detector 120 relative to each other can change the desired S.I.D. For example, an operator could position X-ray source 110 above a patient in a reclined position, and position X-ray imaging detector 120 below the reclined patient. Again, the S.I.D. for such an imaging position could be different from that of a standing patient.

The invention permits the use of a flexible imaging system that is capable of achieving all the positions capable of conventional floor mounted systems. Conventional products are generally much larger, mechanically more complex with inherent disadvantages in usability, cost and reliability. The present invention allows adjustability of the detector and source to achieve all necessary and expected positions for imaging ambulatory and non-ambulatory patients standing, reclining or seated. Thus, the present invention permits a smaller, lighter configuration that is easier to install and takes up far less space than current equipment produced. By virtue of its small size, this invention minimizes the potential for injury to user or patient by accidental contact with the hardware. Moreover, this invention minimizes the potential for collision with obstructions in the installation environment.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### Parts List

10 X-ray imaging detector
15 X-ray source
100 Digital Radiography (DR) System
110 X-ray source
115 X-ray source cables
120 X-ray imaging detector
125 X-ray imaging detector cables
130 First telescoping support member
140 First pivot point
150 Second telescoping support member
160 Second pivot point
170 Moveable base
180 Rotational mechanism
190 Rotational coupling
200 Rotational coupling
210 Rail structure
211 Ceiling
212 X-rails
214 Y-rails
216 First carriage assembly
218 Second carriage assembly
220 Third carriage assembly
300 Motor
310 Horizontal pulley
312 Cables
314 Cables
320 First pulleys
322 First tube section
330 Second pulleys
332 Second tube section
340 Third pulleys
342 Third tube section

1. A digital radiography system for permitting capture of an image of a subject, comprising:
(a) an X-ray source and an X-ray imaging detector;
(b) a moveable base, translatable along two separate directions to a location selected by an operator;
(c) a first rotatable telescoping support member coupled to the moveable base, the X-ray source being rotatably coupled to the first rotatable telescopic support member, and being adapted to translate and rotate to locate the X-ray source in a position selected by the operator; and
(d) a second rotatable telescoping support member coupled to the moveable base, the X-ray imaging detector being rotatably coupled to the second rotatable telescoping support member, and being adapted to translate with the moveable base and rotate to locate the X-ray imaging detector in a position selected by the operator, whereby the movement of the moveable base and the translation and rotation respectively of the first and second telescoping support members positions the X-ray source and the X-ray imaging detector so that an image of the subject can be captured.

2. The digital radiography system of claim 1, further including at least one guide member and wheels formed on the moveable support for permitting movement of the moveable support.

3. The digital radiography system of claim 1, wherein the moveable base is rotatable.
